(19) United States
(12) Patent Application Publication
(10) Pub. No.: US 2026/0092610 A1
(43) Pub. Date: Apr. 2, 2026

(54) Method

(71) Applicant: Hydac Technology GmbH, Sulzbach / Saar (DE)

(72) Inventor: Peter Kloft, Ransbach-Baumbach (DE)

(73) Assignee: Hydac Technology GmbH, Sulzbach / Saar (DE)

(21) Appl. No.: 19/110,504

(22) PCT Filed: Oct. 20, 2023
(86) PCT No.: PCT/EP2023/079258

§ 371 Date: Mar. 11, 2025

(30) Foreign Application Priority Data
Nov. 7, 2022 (DE) 10 2022 129 348.3

(51) Int. Cl. F15B 1/04; B23K 11/14

(52) U.S. Cl. CPC F15B 1/04; B23K 11/14; F15B 2201/605

(57) ABSTRACT

The disclosure relates to a method for producing at least one part of a hydraulic accumulator, comprising at least the following: providing an accumulator housing part that has at least one fluid connection point, providing a connection element with a fluid passage that has a material agglomeration on its one free end face, placing the material agglomeration against the accumulator housing part such that the fluid connection in the accumulator housing part comes into fluidic connection with the fluid passage of the connection element, melting the material agglomeration by means of a welding method, joining the connection element and accumulator housing part under a predefinable pressing force and a predefinable path and allowing the resulting weld connection to cool.

### CROSS-REFERENCE TO RELATED APPLICATIONS

This application claims priority to German Patent Application DE 10 2022 129 348.3, filed on Nov. 7, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for producing at least a part of a hydraulic accumulator and to an hydraulic accumulator manufactured in particular according to this method.

DE 10 2009 049 547 B3 discloses a method for producing a hydropneumatic pressure accumulator, including the method steps: providing a valve body with a protrusion located on the surface directed towards the valve seat, inserting the valve body into an injection mould to form a flexible diaphragm which forms a movable separating element, and injecting an elastomer which forms the diaphragm in such a manner that the valve body is incorporated into the elastomer while leaving the surface directed towards the valve seat exposed.

To complete the hydropneumatic pressure accumulator, the aforementioned arrangement is inserted into an accumulator housing, a housing opening which forms an access to the fluid chamber being located on the accumulator housing, to which housing opening a connecting body adjoins for the purpose of connecting the accumulator to a conventional hydraulic system. For this purpose, the connecting body with its fluid passage in coaxial arrangement with the housing opening in the accumulator housing is firmly connected to the accumulator housing via a circumferential fillet weld.

DE 10 2015 012 357 A1 discloses a hydraulic accumulator, in particular in the form of a diaphragm accumulator, consisting of at least two housing parts of an accumulator housing, in which a separating element, in the form of a separating diaphragm, separates two media chambers from each other, and having at least one media connecting part which is connected to the one housing part along a weld, which media connecting part, as a connecting body for connecting the hydraulic accumulator to a hydraulic system, engages at least partially in a receiving space that is formed in the one housing part along a housing opening, the wall surfaces of the housing and connecting body, which are directed towards each other and mutually adjacent in the receiving space, being firmly connected to each other by means of the weld.

In a hydraulic accumulator construction according to DE 10 2021 000 139 A1, the accumulator housing again has a fluid connection point, which opens out in an adjacent media chamber of the housing and has a connecting body with a fluid passage point, which connecting body is firmly joined to the accumulator housing via a weld, the connecting body having an annular outer circumferential surface on its connection region directed towards the accumulator housing, which outer circumferential surface forms a transition point along which the weld extends when the connecting body is placed on the end face of the accumulator housing.

### SUMMARY

A need exists to allow production of hydraulic accumulators with accumulator housings and connecting bodies in a particularly cost-effective and functionally reliable manner.

The need is addressed by the subject matter of the independent claim(s). Embodiments of the invention are described in the dependent claims, the following description, and the drawings.

### BRIEF DESCRIPTION OF THE DRAWINGS

FIG. 1 shows example joining partners for producing a weld joint in the form of an accumulator housing part and a connecting body;

FIG. 2 shows a modified embodiment of a connecting body according to FIG. 1;

FIGS. 3 and 4 show, viewed from outside and for a basic explanation, the connection of an example connecting body to an example accumulator housing using a welding electrode and an example weld joint produced between the accumulator housing and the connecting body, respectively; and

FIG. 5 shows a longitudinal section through the hydraulic accumulator according to the diagram of FIG. 4.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for producing at least one part of an aforementioned hydraulic accumulator comprises the following method steps:
providing an accumulator housing part, which has at least one fluid connection point,
providing a connecting body with a fluid passage, which has a material agglomeration on its one free end face,
placing the material agglomeration against the accumulator housing part in such a manner that the fluid connection point in the accumulator housing part comes into fluid communication with the fluid passage of the connecting body,
melting the material agglomeration by means of a welding process,
joining the connecting body and accumulator housing part under a predefinable pressing force and a predefinable path and
allowing the weld joint to cool.

By melting the material agglomeration, which is for example an integral part of the connecting body, the welding process can be carried out without filler metals, in such a manner that a particularly homogeneous weld joint is produced between the accumulator housing part and the connecting body. Furthermore, a very strong bond is formed between the components under the high pressing force when the connecting body and the accumulator housing part are joined, which bond can also withstand substantial stresses in subsequent practical operation.

For example, the welding process used is resistance pressure welding, in particular resistance projection welding. In technical terms, the latter welding process is also referred to as projection welding for short and represents a variant of resistance pressure welding. The weld joint is produced by applying electric current to the components to be joined together, in the form of the accumulator housing part together with the associated connecting body, and by the pressing force, which is supplied to the workpieces to be joined together using large-area electrodes.

The material agglomeration on the free end face of the connecting body, which can also be divided into individual joining parts, acts as a projection. The energy input, i.e., the current concentration at the weld point, is then achieved via this material agglomeration, which melts in the process. During the actual welding operation, the molten material agglomeration is therefore largely reshaped by the electrode force and heating as a result of the current flow between the accumulator housing part and the connecting body, this reshaping often not being complete and the projection reshaped during welding then routinely creating a weld joint in the form of a flat nugget, which in the present specific case has a central passage for fluid. Basically, before the welding operation, the reshaped material agglomeration could additionally or alternatively also be arranged on the accumulator housing part which opposes the connecting body that is to be welded on. For projection welding itself, however, it is beneficial to provide the material agglomeration on the connecting body, which can thus be applied to the accumulator housing part configured as a cathode in a particularly simple manner by means of a pressing anode.

A separating element, regularly in the form of a separating diaphragm, can then be inserted into the dome-shaped accumulator housing part with the welded-on connecting body by means of a retainer, and a further dome-shaped accumulator housing part is subsequently welded to the one accumulator housing part to form the hydraulic accumulator, for which various welding processes can be used, in particular a laser welding process which does not require any filler metal. In this way, the interior of the accumulator housing of the hydraulic accumulator can be produced at different manufacturing locations and the pre-welded semi-finished product, consisting of the accumulator housing part and welded-on connecting body, can be completed in a further welding process step, after the separating element has been inserted using the holding device, to form the overall hydraulic accumulator, which can be sealed on its further media side, in particular the gas side, with a sealing plug or a screw plug, which is inserted into a further fluid connection point of the accumulator housing. In this respect, it is also possible to fix the said connecting body not only on the liquid side of the accumulator housing but also on its gas side with a corresponding material agglomeration or projection using projection welding, the further connecting body on the gas side then representing a closure body which can, however, be provided with a refilling device for gas, for example.

The disclosure further relates to a hydraulic accumulator, in particular produced by a method according to the teachings herein, having an accumulator housing and a separating element arranged therein, which separates two media chambers from each other, the accumulator housing having at least one fluid connection point, which opens out into an adjacent media chamber and has a connecting body with a fluid passage, which is firmly connected to the accumulator housing by means of a weld joint, in such a manner that the fluid connection point of the accumulator housing is in fluid communication with the fluid passage of the connecting body, the weld joint between the accumulator housing part and the connecting body being formed from a reshaped material agglomeration, which forms a kind of nugget with a through-hole as part of the fluid connection. In particular, the aforementioned material agglomeration, before it is reshaped as a so-called projection, is part of the connecting body. The electrical contact resistance and the material or substance resistances of the joining partners involved, here in the form of the one accumulator housing part and the associated connecting body, substantially contribute to forming the weld nugget which has a fluid passage. The above-mentioned contact resistance between these joining partners is substantially influenced by the projection geometry, the pressing force via at least one of the electrodes and the surface condition of the accumulator housing part and the connecting body. The weld nugget itself is surrounded by a heat-affected zone, the material structure of the respective joining partner in the said heat-affected zone being changed, in particular homogenised, by the effect of the heat. Ultimately, the welding current, welding current time and the electrode force applied are the setting parameters for creating the suitable weld nugget.

In some embodiments of the hydraulic accumulator, the material agglomeration is formed from an annular projection, which encompasses the fluid passage on the connecting body and which is an integral part of the connecting body. In this case, the annular material agglomeration is for example triangular when viewed in cross-section and an opening angle is produced at the apex of the triangle which is between 70° to 110°, or for example between 80° to 100° or for example approximately 90°. It has been shown that the geometric triangular shape for the projection, particularly in respect of the material thickness and material strength, is also particularly suited to ensuring good force transmission together with optimised reshaping for the material agglomeration towards production of the weld nugget between the said joining partners.

It is also beneficial in this case if the material agglomeration merges on the outer and/or inner circumference into a boundary surface, which is perpendicular to the longitudinal axis of the connecting body. The respective boundary surface also provides support during the reshaping process, resulting in an improved weld connection. Alternatively to this, it is also possible to have the boundary surface merge at a predefinable angle into an inclined surface on the outer circumference, which is part of the one free end face of the connecting body. In this way, it is also possible to reliably support the reshaping process such that the degree to which the material agglomeration or the projection is reshaped cannot be inadmissibly high before the actual welding process even begins.

It is for example provided that the boundary surface merges on the inner circumference into a threaded region in vertical extension, viewed parallel to the longitudinal axis of the connecting body, which helps to make it considerably easier to connect the hydraulic accumulator as a whole to a fluid or hydraulic system via an associated threaded fitting assembly.

Another benefit is that the weld/joint zone can be examined by means of a non-destructive test method such as ultrasound. The inner side of the half-shell creates an ideal surface for irradiation. This makes it possible to identify pores or lack of fusion defects.

The solution is discussed in greater detail below with reference to further embodiments according to the FIGS. Specific references to components, process steps, and other elements are not intended to be limiting. Further, it is understood that like parts bear the same or similar reference numerals when referring to alternate FIGS. The FIGS. are schematic and not necessarily to scale.

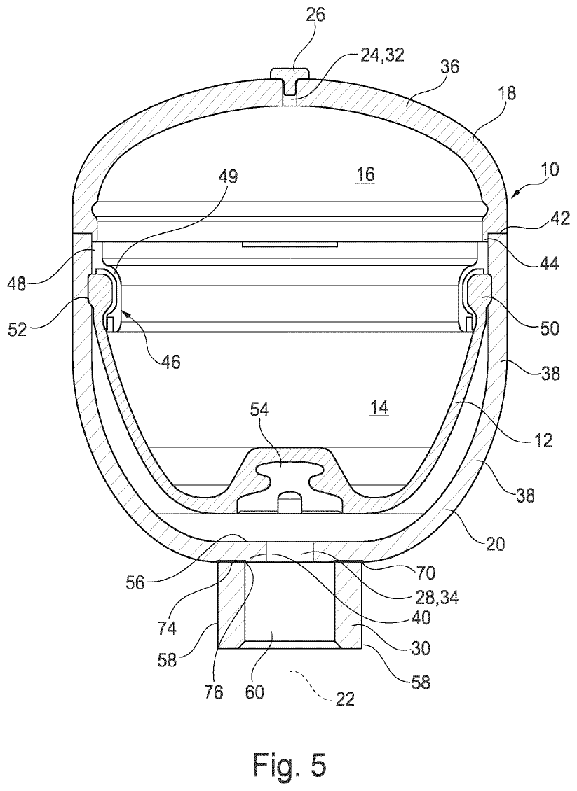

The hydraulic accumulator shown in longitudinal section in FIG. 5 is a so-called diaphragm accumulator with a separating element 12, in the form of a diaphragm made of elastomeric material, arranged in an accumulator housing denoted as a whole by 10. This diaphragm separates the interior of the housing 10 into a media chamber 14, in the form of a fluid chamber for storing a liquid, in particular in the form of hydraulic oil, and a further media chamber 16, in the form of a gas chamber for storing a working gas, in particular in the form of nitrogen gas.

Viewed in the direction of FIG. 5, the housing 10 consists of an upper accumulator housing part 18 and a lower accumulator housing part 20, each of which has a circular shell or dome shape with a central axis 22, which corresponds to the longitudinal axis of the hydraulic accumulator. The upper accumulator housing part 18 has a shallower shell shape than the lower accumulator housing part 20. At the end of the accumulator housing 10 opposing the fluid chamber 14, i.e., at the end associated with the gas chamber 16, the upper accumulator housing part 18 has an upper fluid connection point 24 concentric with the axis 22, which can be sealed by means of a plug or by means of solder 26 after filling the gas chamber 16. On the lower accumulator housing part 20, a lower fluid connection point 26 is provided concentric with the axis 22, at which fluid connection point a lower connecting body 30 is attached as an oil connection, via which the accumulator can be connected to a hydraulic system, not shown, in the usual way.

The upper 18 and the lower 20 accumulator housing part have a central upper 32 and lower 34 fluid channel, respectively, which in each case extends centrally along the longitudinal axis 22 through an accumulator housing wall 36 of the upper accumulator housing part 18 and opens out into the gas chamber 16 or, starting from the lower fluid connection point 28, extends centrally through an accumulator housing wall 38 of the lower accumulator housing part 20 and opens out into the fluid chamber 14. In this case, the respective channel 32, 34 is part of the upper 24 or the lower 28 fluid connection point, respectively. Starting from a constant outer diameter, the housing wall 36 of the upper accumulator housing part 18 extends away from the lower accumulator housing part 20 and, curving outwards, towards the longitudinal axis 22 of the hydraulic accumulator up to the central upper fluid channel 32. In contrast, starting from a constant outer diameter, the housing wall 38 of the lower accumulator housing part 20 initially extends away from the upper accumulator housing part 18 and, curving outwards, towards the longitudinal axis 22 of the hydraulic accumulator and then merges into a plate 40, which is flat and disc-shaped on both sides, through which the lower fluid channel 34, as the lower fluid connection point 28, extends centrally.

The upper 18 and the lower 20 accumulator housing part, which abut each other along a weld point 42, are joined together by means of a laser or electron beam welding process and, in order to protect the interior of the accumulator housing part 10 from weld spatter and/or heat input during welding, the upper accumulator housing part 18 is provided on the inner circumference with an annular rim 44 protruding downwards which, as a rim protrusion, covers the weld point 42 inwardly in a protective manner as soon as the two housing parts 18, 20 are placed against each other.

Provided below the annular rim 44 and adjacent thereto is a retainer denoted as a whole by 46, which has a retaining ring 48 with an annular receptacle 49 for receiving a thickened, circumferential rim bead 50 of the diaphragm-like separating element 12. Furthermore, the rim bead 50 is supported on the outer circumference in a groove-shaped receptacle 52 or indentation on the inner wall of the lower accumulator housing wall 38, so that in this way the receptacle 52 together with the annular receptacle 49 in the retaining ring 48 form a seat for the thickened rim bead 50. If the retaining ring 48 is formed from a sheet metal part, the rim bead 50 and consequently the separating element 12 can be fixed to the lower accumulator housing wall 38 using the inherent elasticity of the retaining ring 48.

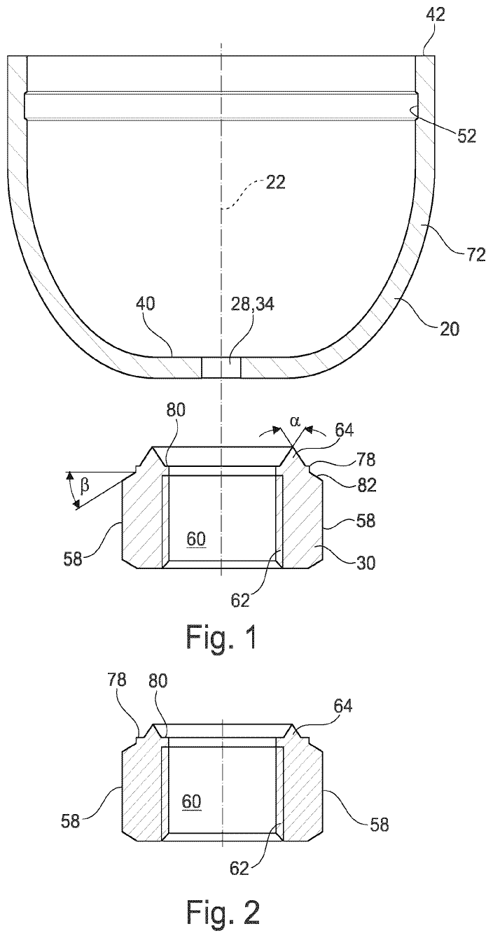

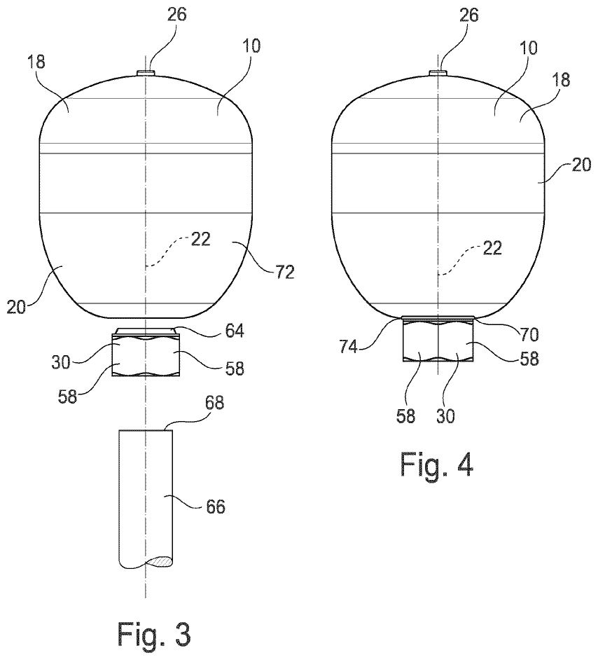

Furthermore, the separating element 12 as the separating diaphragm has a solid valve body 54, which can cover a rim 56 of the inlet of the lower fluid connection point 28, which rim forms a kind of valve seat, provided that the valve body 54 comes into contact with the said rim 56 in the lowest deflected position of the separating element 12. As shown in particular in FIGS. 3 and 4, the connecting body 30 can have engagement surfaces 58 for the engagement of an operating tool, in the form of a conventional hexagonal wrench, for example, for improved fitting of the hydraulic accumulator to a hydraulic system. As FIGS. 1, 2 and 5 show in particular, the connecting body 30 also has a fluid passage 60 which extends concentric with the longitudinal axis 22 of the hydraulic accumulator, provided that the connecting body 30 is firmly connected to the accumulator housing 10. In particular, the free cross-section of the fluid passage 60 is larger in size than the channel diameter for the lower fluid connection point 28. As can further be seen from FIGS. 1 and 2, the fluid passage 60 is at least partially provided with a conventional internal thread as threaded region 62, which enables the hydraulic accumulator according to FIG. 5 to be screwed onto connecting parts of the hydraulic system. An aforementioned connection coupling between hydraulic accumulator and hydraulic system is common, with the result that it will not be discussed in greater detail at this point. Based on the conventional construction of a hydraulic accumulator according to FIG. 5, the manufacturing method according to the teachings herein will now be explained in greater detail with reference to FIGS. 1 to 4, the components which have been described and used above being provided with the same reference numerals as in FIG. 5, and the remarks made in this respect also applying to the description of the method sequence according to FIGS. 1 to 4.

In the manufacturing method according to the teachings herein, the lower accumulator housing part 20 is first connected to the connecting body 30, which is shown in greater detail in FIG. 1. First the lower accumulator housing part 20, which has the lower fluid connection point 28, is provided. In addition, the connecting body 30 with its fluid passage 60 is provided, which has a material agglomeration 64, also referred to in technical terms as a projection, on its free, upper end face. In a further method step, the material agglomeration 64 of the connecting body 30 is fixed to the lower accumulator housing part 20 in such a manner that the fluid connection point 28 in the accumulator housing part 20 comes into fluid communication with the fluid passage 60 of the connecting body 30, both the fluid connection point 28 and the fluid passage 60 of the connecting body 30 being in concentric arrangement with the longitudinal axis 22 of the hydraulic accumulator.

The material agglomeration 64 is then melted by means of a special welding process which will be explained in greater detail. The basic requirement for welding, however, is joining together the connecting body 30 and the lower accumulator housing part 28 under a predefinable pressing force which, according to the diagram of FIG. 3, is for example applied by a vertically displaceable electrode in the form of an anode 66, which is only partially shown in FIG. 3 and which merges at its upper end or at its upper free end face into a flat contact surface 80, which can be brought into even contact with the underside of the connecting body 30. The weld joint 70 produced in this respect according to the diagram of FIGS. 3 and 5 is then allowed to cool with the result that a permanent connection is created between the accumulator housing part 20 and the connecting body 30.

According to the teachings herein, a so-called resistance pressure welding process, in particular a resistance projection welding process, is used as the welding process. In resistance projection welding, as already explained, the connecting body 30 is pressed by means of the anode 66 against the accumulator housing part 18 as the cathode 72 with a predefinable pressing force and, when an electric voltage or a current is correspondingly applied both to the anode 66 and to the cathode 72, the material agglomeration 60 is melted due to the associated contact resistance when the connecting body 30 is placed on the underside of the accumulator housing part 20 and, due to the pressing force via the anode 66, reshaping of the material agglomeration 64 takes place until an annular weld nugget 74 is obtained, which produces the actual weld joint 70 between the accumulator housing part 20 and the connecting body 30 after it has cooled. In this case, the weld nugget 74, in the manner of a circular ring, has a through-hole 76 which with optimum welding corresponds to the inner diameter of the fluid passage 60 of the connecting body 30, as can be seen in particular from the diagram according to FIG. 5.

As FIG. 1 shows, the material agglomeration 64 is formed from an annular projection, which encompasses the fluid passage 60 on the connecting body 30 and which is an integral part of the connecting body 30. Furthermore, the annular material agglomeration 64 is triangular when viewed in cross-section and the two adjacent legs of the triangle define between them an opening angle α at their apex, which is approximately 80°. In addition, in the solution according to FIG. 1, the material agglomeration 64 which is: triangular when viewed in cross-section merges on both the outer and inner circumference into a boundary surface 78, 80, which is perpendicular in each case to the longitudinal axis 22. In this way, the annular boundary surfaces 78, 80, which adjoin the base of the material agglomeration 64, provide support for it during reshaping as part of the welding process. In addition, a further annular support surface 82 adjoins the outer circumferential boundary surface 78, which support surface, when viewed in the direction of FIG. 1, has an angle of inclination 3 of approximately 30° with respect to the horizontal. The aforementioned support surface 82 also contributes to a favourable reshaping behaviour of the material agglomeration 64 during the welding process. On the outer circumference, the support surface 82 then merges into the adjacent tool engagement surfaces 58 and, on the inner circumference, the inner boundary surface 80 defines the threaded region 62 of the connecting body 30. The inclined support surface 82 also allows material to flow away smoothly in the edge region of the triangular material agglomeration 64 as part of reshaping during the welding operation, in order to obtain a geometrically optimum weld nugget 74 in this way. In this case, the two boundary surfaces 78, 80 are located in a common plane.

The embodiment of a connecting body 30 according to FIG. 2 corresponds largely to the embodiment according to FIG. 1, providing that the material agglomeration 64, which is triangular when viewed in cross-section, turns out smaller than the material agglomeration 64 according to FIG. 1. Thus the reduced material agglomeration according to FIG. 2 may well be sufficient to produce a permanent weld joint between the connecting body 30 and the accumulator housing part 20 during projection welding. In a further production method step, the separating element 12 together with the retainer 46 is then inserted into the lower accumulator housing part 20 from above and the rim bead 50 of the separating element 12 is clamped firmly in the receptacle 52 of the lower accumulator housing part 20 by means of the retaining ring 48. The upper accumulator housing part 18 is then placed in position and a permanent connection between the two accumulator housing parts 18, 20 is produced along the weld seam point 42 by means of laser welding or similar, as already described. Subsequently, the hydraulic accumulator completed in this way can be filled on its gas side or the further media chamber 16 with a working gas, such as nitrogen gas, at a predefinable pressure via the upper fluid connection point 24, which is then sealed gas-tight by a plug or the solder 26.

Basically, it is also possible to arrange a connecting body 30 as presented on the gas side, i.e., the solder 26 can be omitted and the connecting body 30 is fixed to the upper side of the upper accumulator housing part 18 in the edge region of the upper fluid connection point 24 by means of projection welding in a similar way to that presented. If necessary, an aforementioned connecting body, not shown, can also be used to refill the hydraulic accumulator with working gas and to seal the gas side, for example by inserting a screw-in plug into the fluid passage 60 of the connecting body 30 (not shown).

Basically, it is also possible to use the described resistance welding to fix a gas valve on the gas side of the accumulator, which is particularly beneficial for accumulators that can be refilled on the gas side. Where the term fluid is used above, this includes not only liquids, such as hydraulic oil, but also gases, such as nitrogen gas.

It should be emphasised at this point that the solution according to the teachings herein need not be restricted to hydraulic accumulators in the form of diaphragm accumulators but can rather be used whenever corresponding connecting bodies with fluid passage are to be fixed to accumulator housings of pressure accumulators which have corresponding fluid connection points.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example”or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A method for producing at least one part of a hydraulic accumulator comprising:
providing an accumulator housing part, which has at least one fluid connection point;
providing a connecting body with a fluid passage, which has a material agglomeration on its one free end face;
placing the material agglomeration against the accumulator housing part so that the fluid connection point in the accumulator housing part comes into fluid communication with the fluid passage of the connecting body;
melting the material agglomeration using a welding process;
joining the connecting body and accumulator housing part under a predefinable pressing force and a predefinable path; and
allowing the resulting weld joint to cool.

12. The method of claim 11, wherein the welding process is resistance pressure welding.

13. The method of claim 11, wherein, the welding process is resistance projection welding and as part of resistance projection welding, the connecting body is applied using an anode against the accumulator housing part as a cathode with the predefinable pressing force.

14. The method of claim 11, wherein a separating element is inserted into the accumulator housing part with the welded-on connecting body using a retainer and wherein a further accumulator housing part is subsequently welded to the accumulator housing part to form the hydraulic accumulator.

15. A hydraulic accumulator, having an accumulator housing and a separating element arranged therein, which separates two media chambers from each other, wherein the accumulator housing has at least one fluid connection point, which opens out into an adjacent media chamber and having a connecting body with a fluid passage, which is firmly connected to the accumulator housing by a weld joint, in such a manner that the fluid connection point of the accumulator housing is in fluid communication with the fluid passage of the connecting body, wherein the weld joint between the accumulator housing part and the connecting body is formed from a reshaped material agglomeration of the connecting body, which forms a nugget with a through-hole as part of the fluid connection.

16. The hydraulic accumulator of claim 15, wherein the material agglomeration is formed from an annular projection, which encompasses the fluid passage on the connecting body and which is an integral part of the connecting body.

17. The hydraulic accumulator of claim 15, wherein the annular material agglomeration is triangular when viewed in cross-section and has an opening angle (α) at the apex of 70° to 110°, or of 80° to 100°, or of 90°.

18. The hydraulic accumulator of claim 15, wherein the material agglomeration merges on the outer and/or inner circumference into a boundary surface, which is perpendicular to the longitudinal axis of the connecting body.

19. The hydraulic accumulator of claim 18, wherein the outer boundary surface merges on the outer circumference at a predefinable angle into a supporting surface, which is part of the one free end face of the connecting body.

20. The hydraulic accumulator of claim 18, wherein the inner circumferential boundary surface merges into a threaded region of the connecting body, in vertical extension when viewed parallel to the longitudinal axis thereof.

21. The hydraulic accumulator of claim 15, produced by the method of claim 1.

22. The method of claim 12, wherein a separating element is inserted into the accumulator housing part with the welded-on connecting body using a retainer and wherein a further accumulator housing part is subsequently welded to the accumulator housing part to form the hydraulic accumulator.

23. The method of claim 13, wherein a separating element is inserted into the accumulator housing part with the welded-on connecting body using a retainer and wherein a further accumulator housing part is subsequently welded to the accumulator housing part to form the hydraulic accumulator.

24. The hydraulic accumulator of claim 6, wherein the annular material agglomeration is triangular when viewed in cross-section and has an opening angle (α) at the apex of 70° to 110°, or of 80° to 100°, or of 90°.

25. The hydraulic accumulator of claim 16, wherein the material agglomeration merges on the outer and/or inner circumference into a boundary surface, which is perpendicular to the longitudinal axis of the connecting body.

26. The hydraulic accumulator of claim 17, wherein the material agglomeration merges on the outer and/or inner circumference into a boundary surface, which is perpendicular to the longitudinal axis of the connecting body.

27. The hydraulic accumulator of claim 19, wherein the inner circumferential boundary surface merges into a threaded region of the connecting body, in vertical extension when viewed parallel to the longitudinal axis thereof.
